(19) United States
(12) Patent Application Publication
(10) Pub. No.: US 2013/0136635 A1
(43) Pub. Date: May 30, 2013

(54) MOTOR AND ELECTRIC PUMP

(71) Applicant: AISAN KOGYO KABUSHIKI KAISHA, Aichi-ken (JP)

(72) Inventor: Takahiro Nakamura, Aichi-ken (JP)

(73) Assignee: AISAN KOGYO KABUSHIKI KAISHA, Aichi-ken (JP)

(21) Appl. No.: 13/683,563

(22) Filed: Nov. 21, 2012

(30) Foreign Application Priority Data
Nov. 24, 2011 (JP) 2011-255987

(51) Int. Cl. F04D 25/06; H02K 1/18

(52) U.S. Cl. CPC F04D 25/06; H02K 1/185
USPC 417/423.7; 310/43

(57) ABSTRACT

A stator of a motor may comprise a first core, a second core and a resin layer. Each of the first core and the second core may comprise a yoke and three pieces of teeth configured to be disposed on the yoke. The resin layer may comprise a first void configured to contact a first opposing surface, opposing the second core, of the first core and contact a second opposing surface, opposing the first core, of the second core and a second void configured to contact a first part, extending parallel to a direction along which the first core opposes the second core, of a surface of the first core and contact a second part, extending parallel to the direction along which the first core opposes the second core, of a surface of the second core.

### CROSS-REFERENCE TO RELATED APPLICATION

This application claims priorities to Japanese Patent Application No. 2011-255987, filed on Nov. 24, 2011, the contents of which are hereby incorporated by reference into the present application.

### TECHNICAL FIELD

The present application discloses a motor and an electric pump.

### DESCRIPTION OF RELATED ART

Japanese Patent Application Publication No. 2009-17746 discloses a motor including a stator configured by a plurality of cores. The plurality of cores is disposed side by side in a ring shape around a rotor. The respective cores are in contact with the cores adjacent thereto. The plurality of cores is covered with a resin layer. The resin layer is molded by insert molding with the plurality of cores disposed in a molding die. When the plurality of cores is set in the molding die, a pressing pin disposed in the molding die slides and presses the plurality of cores from an outer side to an inner side of the ring shape. As a result, the plurality of cores is pressed against a cored bar of the molding die disposed on the inner side of the ring shape and is positioned with respect to the molding die. Each of the plurality of cores is set in contact with the cores on both ends adjacent thereto and positioned with respect to the adjacent cores at both the ends.

### SUMMARY

In a case where a stator is configured by separated two cores, the two cores cannot be set in contact with each other in the molding die. Therefore, unlike Japanese Patent Application Publication No. 2009-17746, relative positions of the cores cannot be determined by setting the cores in contact with each other. When the relative positions of the two cores deviate, a space between the stator and the rotor is not fixed. Therefore, rotation of the rotor is not stabilized and efficiency of the motor is deteriorated. In this specification, a technique is provided that suppress relative positional deviation of the two cores.

An aspect of the disclosure herein is a motor. The motor may comprise a rotor and a stator. The stator may be configured to comprise a first core, a second core which opposes the first core, and a resin layer covering the first core and the second core so as to connect the first core and the second core. Each of the first core and the second core may comprise a yoke and three pieces of teeth. The three pieces of teeth may be configured to be disposed on the yoke. A rear end of each of the teeth may be connected with the yoke. A front end of each of the teeth may oppose an outer circumference of the rotor with a clearance. The resin layer may comprise a space configured to dispose the rotor, a first void and a second void. The first void may be configured to: contact a first opposing surface of the first core, the first opposing surface opposing the second core; and contact a second opposing surface of the second core, the second opposing surface opposing the first core. The second void may be configured to: contact a first part of a surface of the first core, the first part extending parallel to a direction along which the first core opposes the second core; and contact a second part of a surface of the second core, the second part extending parallel to the direction along which the first core opposes the second core.

With this configuration, when the resin layer that connects the first core and the second core is molded by insert molding, parts of a molding die are disposed in positions where the first void and the second void are formed. The first void contacts the first opposing surface of the first core and the second opposing surface of the second core. Therefore, the opposing surface of the first core and the opposing surface of the second core are in contact with the part of the molding die disposed in the position where the first void is formed. Therefore, first positioning of the first core and the second core may be performed by the part of the molding die disposed in the position where the first void is formed. Therefore, during the molding of the resin layer, it is possible to suppress the first core and the second core from positionally deviating in a direction along which the first core and the second core approach. The second void contacts a part (the surface extending in parallel to the direction along which the first core opposes the second core) of the surface of the first core and a part (the surface extending in parallel to the direction along which the first core opposes the second core) of the surface of the second core. Therefore, the part of the molding die disposed in the position where the second void is formed is also in contact with the part of the surface of the first core and the part of the surface of the second core. Therefore, when the resin layer is molded, second positioning of the first core and the second core may be performed by the part of the molding die disposed in the position where the second void is formed. Therefore, during the molding of the resin layer, it is possible to suppress the first core and the second core from positionally deviating in a direction perpendicular to the direction along which the first core opposes the second core. In other words, since relative positions of the two cores are determined by the resin layer in a state in which the positional deviation is suppressed, relative positional deviation of the two cores may be suppressed.

Another aspect disclosed herein is an electric pump comprising the above mentioned motor. The electric pump may comprise the above mentioned motor, an impeller configured to be activated by the motor and a pump chamber configured to contain the impeller rotatably. In the electric pump, since the motor is used, the clearance between the stator and the rotor from fluctuating in the circumferential direction of the rotor may be suppressed. As a result, deterioration in pump efficiency may be suppressed.

### BRIEF DESCRIPTION OF DRAWINGS

FIG. 1 shows a schematic longitudinal sectional view of an electric pump.

FIG. 2 shows a diagram for explaining a method of molding a resin layer.

FIG. 3 shows a plan view of two cores in a state in which the cores are placed on a supporting member.

FIG. 4 shows a side view of the two cores in the state in which the cores are placed on the supporting member.

FIG. 5 shows a bottom view of a stator.

FIG. 6 shows a plan view of the stator.

### DETAILED DESCRIPTION

Some of other aspects of the motor disclosed herein will be described below. The resin layer of the motor may further comprise a third void and a fourth void. The third void may be configured to contact a third part of the surface of the first core. The third part may be located on an opposite side from the second core. The fourth void may be configured to contact a fourth part of the surface of the second core. The fourth part may be located on an opposite side from the first core. With this configuration, when the resin layer is molded by the insert molding, third positioning for suppressing the first core and the second core from positionally deviating in a direction along which the first core separates from the second core may be performed by a part of the molding die disposed in positions where the third and fourth voids are formed. As a result, when the resin layer is molded, the first core and the second core may be suppressed from positionally deviating in the direction along which the first core separates from the second core.

Each of the first void, the second void, the third void and the fourth void may open at a lower end portion of the motor and extend from the lower end portion toward an upper end portion of the motor. The first void and the second void may be deeper than the third void and the fourth void. With this configuration, the part for performing the first positioning and the second positioning can be set larger than the part for performing the third positioning.

Another aspect disclosed herein is an electric pump comprising the above mentioned motor. The electric pump may comprise the above mentioned motor, an impeller configured to be activated by the motor, a pump chamber configured to be disposed above the motor and contain the impeller rotatably, a control circuit configured to control the motor and a control chamber configured to be disposed below the motor and contain the control circuit. With this configuration, the pump chamber and the control chamber may be isolated by the resin layer. Parts of the cores are exposed to the first to fourth voids. Since the control chamber is disposed below the motor, there is no concern about fluid intruding into the first to four voids from the pump chamber. It is unnecessary to close the first to fourth voids.

The three pieces of the teeth disposed on the same yoke may comprise a pair of first teeth configured to connect to both edges of the yoke and a second tooth configured to connect to a center part of the yoke. Each of the pair of the first teeth of the first core may oppose a corresponding one of the pair of the first teeth of the second core. A front portion of each of the first teeth of the first core and the corresponding first teeth of the second core may comprise an opposing area opposing the rotor and a non-opposing area not opposing the rotor. For each of the pair of the first teeth of the first core, the first opposing surface may be located in the non-opposing area of the first teeth. For each of the pair of the first teeth of the second core, the second opposing surface may be located in the non-opposing area of the first teeth. With this configuration, the first void is disposed outside the range in which the rotor and the stator (i.e., the first teeth) oppose. As a result, it is unnecessary to increase the clearance between the rotor and the stator for the sake of gaining a space to form the first void.

The pump chamber may be communicated with the space in which the rotor is disposed. A groove may be disposed between two adjacent teeth on a surface of the resin layer opposing the rotor. The groove may extend along a direction of a rotation axis of the rotor. In this configuration, the fluid may flow into the space in which the rotor is disposed from the pump chamber. The groove extending in the rotation axis direction of the rotor is disposed in the resin layer. Therefore, a channel area of the fluid flowing into the space in which the rotor is disposed may be increased. Therefore, the fluid may smoothly flow, by passing the groove, in the space in which the rotor is located.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved motor and electric pump, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

(Configuration of an Electric Pump 10)

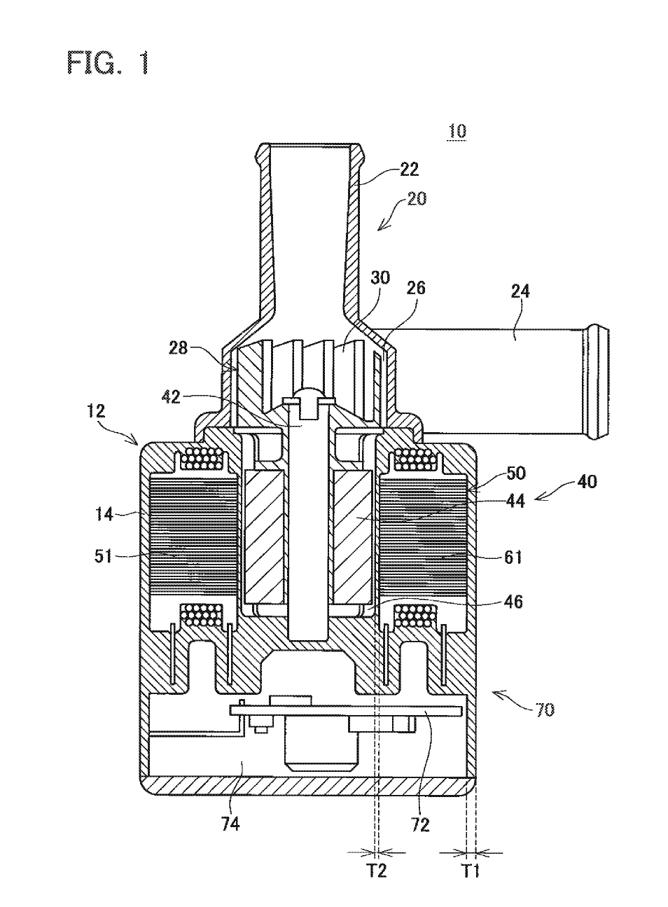

An electric pump 10 is set in an engine room of an automobile and used for circulating cooling water for cooling an engine, an inverter, and the like. As shown in FIG. 1, the electric pump 10 includes a pump unit 20, a motor unit 40, and a circuit unit 70.

The pump unit 20 is formed above a casing 12. The pump unit 20 includes a pump chamber 26. A suction port 22 and a discharge port 24 formed in the casing 12 are connected to the pump chamber 26. The suction port 22 is connected to an upper end of the pump chamber 26. The suction port 22 extends in a direction along which a rotation axis of a rotating body 28 extends. The discharge port 24 is connected to an outer circumference of the pump chamber 26. The discharge port 24 extends in a tangential direction of the outer circumference of the pump chamber 26. An impeller 30 of the rotating body 28 is disposed in the pump chamber 26.

The motor unit 40 is disposed below the pump unit 20. The motor unit 40 configures a brushless motor. The motor unit 40 comprises a fixed shaft 42, a rotor 44, and a stator 50. A lower end of the fixed shaft 42 is fixed to the casing 12. The fixed shaft 42 extends in an up-down direction in the casing 12. A distal end of the fixed shaft 42 reaches an inside of the pump chamber 26. The rotating body 28 is rotatably attached to the fixed shaft 42. The rotating body 28 comprises the impeller 30 and the rotor 44. A plurality of blades is formed at a fixed interval on an upper surface of the impeller 30. The rotor 44 having a cylindrical shape is disposed below the impeller 30. The rotor 44 is formed of a magnetic material and subjected to magnetization treatment to have a plurality of magnetic poles in a circumferential direction thereof. The impeller 30 and the rotor 44 are integrally coupled. Therefore, when the rotor 44 rotates, the impeller 30 also rotates. The stator 50 is disposed on an outer circumferential side of the rotor 44 and opposes the rotor 44. A detailed configuration of the stator 50 is explained in detail below.

The circuit unit 70 is disposed below the motor unit 40. The circuit unit 70 includes a circuit chamber 74. In the circuit chamber 74, a control circuit 72 that performs control of power supply to the stator 50 is disposed. The control circuit 72 is connected to a not-shown external power supply (e.g., a battery mounted on a vehicle) by a not-shown wire. The control circuit 72 supplies electric power, which is supplied from the external power supply, to the motor unit 40.

(Configuration of the Stator 50)

Next, the stator 50 is explained in detail. The stator 50 includes two cores 51 and 61 and a resin layer 14. Each of the cores 51 and 61 is formed by laminating a plurality of electromagnetic steel plates. The two cores 51 and 61 are covered with the resin layer 14 that configures the casing 12. The two cores 51 and 61 are integrated by the resin layer 14.

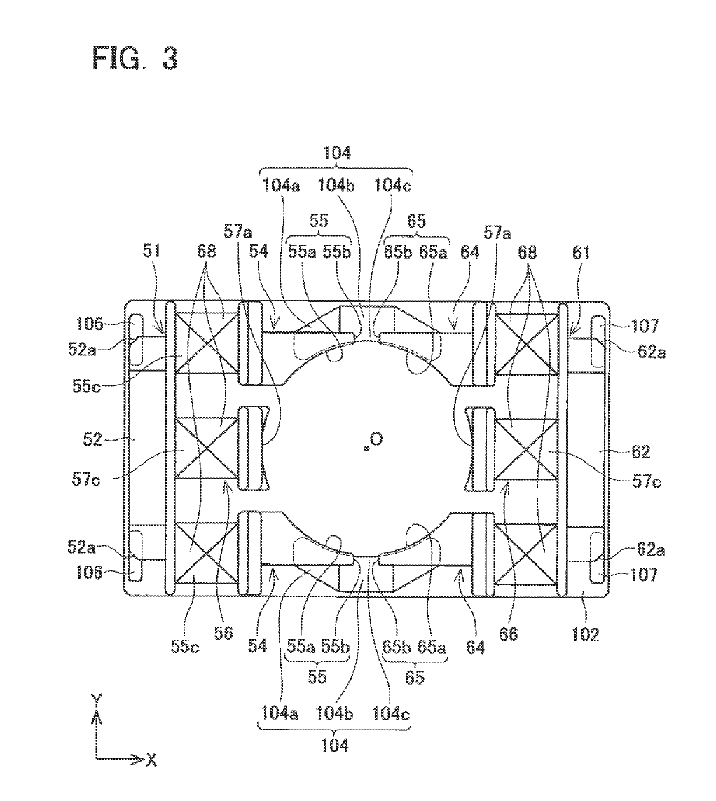

The two cores 51 and 61 are disposed symmetrically across the rotor 44 in a state in which the cores 51 and 61 are separated from each other. As shown in FIG. 3, the first core 51 comprises one yoke 52 and three pieces of teeth 54, 56, and 54. The second core 61 comprises one yoke 62 and three pieces of teeth 64, 66, and 64. The second core 61 has the same configuration as the first core 51 except that the second core 61 is disposed symmetrically to the first core 51 across the rotor 44. Therefore, in the following explanation, the first core 51 is mainly explained.

The yoke 52 extends in a Y direction. The three pieces of the teeth 54, 56, and 54 are connected to the yoke 52. Rear ends of the three pieces of the teeth 54, 56, and 54 are connected to the yoke 52 and, on the other hand, front ends of the three pieces of the teeth 54, 56, and 54 oppose the outer circumference of the rotor 44 with a clearance. The teeth 54, 56, and 54 are disposed in parallel to one another. The teeth 54, 56, and 54 extend in an X direction from the yoke 52 toward the second core 61.

The three pieces of the teeth 54, 56, and 54 are configured by a pair of first teeth 54 connected to both edges of the yoke 52 and a second tooth 56 connected to a center part of the yoke 52. An opposing surface 55 on the front end side (i.e., an end on the rotor 44 side) of each the first teeth 54 opposes an opposing surface 65 on the front end side of each of the first teeth 64 explained below. The opposing surface 55 is divided into a rotor side surface 55a opposing the rotor 44 and a non-rotor side surface 55b not opposing the rotor 44. The rotor side surface 55a is formed in a shape extending along an external circumferential shape of the rotor 44. The non-rotor side surface 55b is formed in parallel to the yoke 52. A coil 68 is wound around an intermediate section 55c of each of the first teeth 54. The coil 68 is connected to a control circuit 72 by a not-shown wire.

A front end face 57a on the front end side (i.e., an end on the rotor 44 side) of the second tooth 56 is formed in a shape extending along the outer circumferential shape of the rotor 44. A coil 68 is wound around an intermediate section 57c of the second tooth 56. The coil 68 is connected to the control circuit 72 by a not-shown wire.

The yoke 62 and the three pieces of the teeth 64, 66, and 64 connected to the yoke 62 have the same configuration as the yoke 52 and the three pieces of the teeth 54, 56, and 54. Specifically, rear ends of the three pieces of the teeth 64, 66, and 64 (i.e., first teeth 64 and a second tooth 66) are connected to the yoke 62 and, on the other hand, front ends of the three pieces of the teeth 64, 66, and 64 oppose the outer circumference of the rotor 44 with a clearance.

The first teeth 54 and the first teeth 64 in a symmetrical positional relation oppose across the rotor 44. More specifically, the rotor side surface 55a of each the first teeth 54 opposes a rotor side surface 65a of the front end 65 of the corresponding first tooth 64 across the rotor 44. On the other hand, the non-rotor side surface 55b of each of the first teeth 54 opposes the non-rotor side surface 65b of the corresponding first tooth 64 with a clearance and without being across the rotor 44.

(Method of Molding the Resin Layer 14)

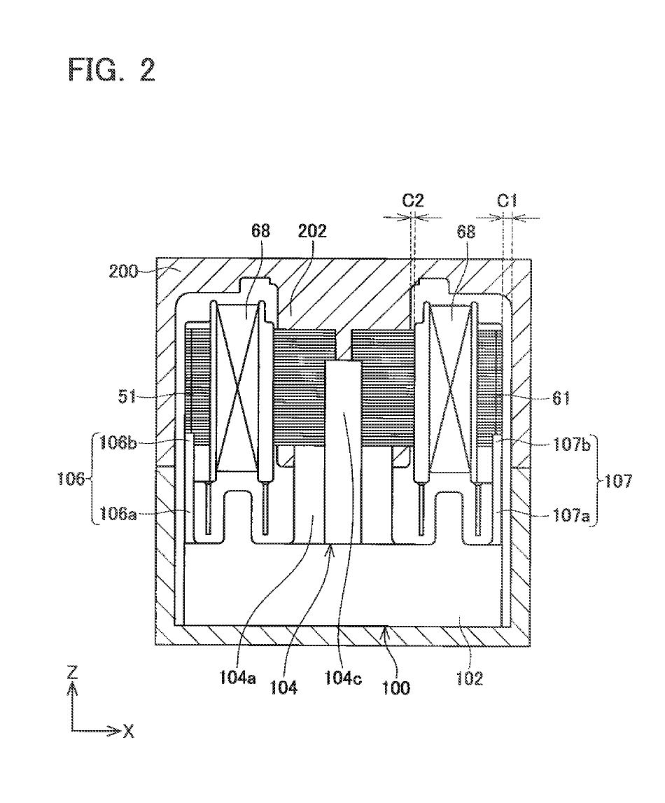

A method of molding the resin layer 14 is explained. As shown in FIG. 2, the resin layer 14 is molded by insert molding for disposing the two cores 51 and 61 in a molding die 200 and molding the cores 51 and 61. The molding die 200 comprises a supporting device 100 that supports the two cores 51 and 61 in the molding die 200.

In the molding of the resin layer 14, first, the two cores 51 and 61 are set on the supporting device 100. The supporting device 100 comprises a base member 102 having a rectangular parallelepiped shape, two center positioning members 104, and four end positioning members 106 and 107. The positioning members 104 to 107 extend in a Z direction from an upper surface of the base member 102.

The center positioning member 104 is disposed to oppose the other center positioning member 104 in a center O (see FIG. 3) in the X direction of the upper surface of the base member 102. Each of the center positioning members 104 comprises a lower supporting section 104a, a first positioning section 104b, and a second positioning section 104c. The lower supporting section 104a extends in the Z direction from the upper surface of the base member 102. One piece of the first teeth 54 and one piece of the first teeth 64 opposing the first teeth 54 are placed on an upper surface of the lower supporting section 104a. In the lower supporting section 104a, a surface located on the center O (see FIG. 3) side in the Y direction (i.e., a side surface opposing the other lower supporting section 104a) (hereinafter simply referred to as “inner surface of the lower supporting section 104a”) is formed in a shape extending along the outer circumferential shape of the rotor 44.

A first positioning section 104b and a second positioning section 104c are disposed on the upper surface of each of the lower supporting sections 104a. In a state in which the two cores 51 and 61 are set on the supporting device 100, the first positioning section 104b is located between the non-rotor side surfaces 55b and 65b of the first teeth 54 and 64 on respective sides. Specifically, the non-rotor side surface 55b of the first teeth 54 is in contact with a left side surface of the first positioning section 104b. The non-rotor side surface 65b of the first teeth 64 is in contact with a right side surface of the first positioning section 104b. The first positioning sections 104b prevent the two cores 51 and 61 from approaching. Each of the first positioning sections 104b has a curved surface continuous to the rotor side surfaces 55a and 65a of the first teeth 54 and 64 disposed on both sides of the first positioning section 104b (i.e., a surface formed in a shape extending along the outer circumferential shape of the rotor 44). Height (i.e., height from the upper surface of the lower supporting section 104a) of each of the first positioning sections 104b is smaller than height of the two cores 51 and 61 in the state in which the cores 51 and 61 are set on the supporting device 100 and is larger than height of a center of gravity of the cores 51 and 61.

On an outer side in the Y direction of the first positioning section 104b, the second positioning section 104c is disposed in a state in which the second positioning section 104c is in contact with the first positioning section 104b. In the state in which the two cores 51 and 61 are set on the supporting device 100, the second positioning section 104c is set in contact with surfaces of the first teeth 54 and 64 on an opposite side (i.e., outer side) of the rotor side surfaces 55a and 56a. In other words, the two cores 51 and 61 are held between two second positioning sections 104c in the Y direction. The second positioning sections 104c prevent the two cores 51 and 61 from deviating in the Y direction. Height (i.e., height from the upper surface of the lower supporting section 104a) of each of the second positioning sections 104c is the same as height of the first positioning sections 104b.

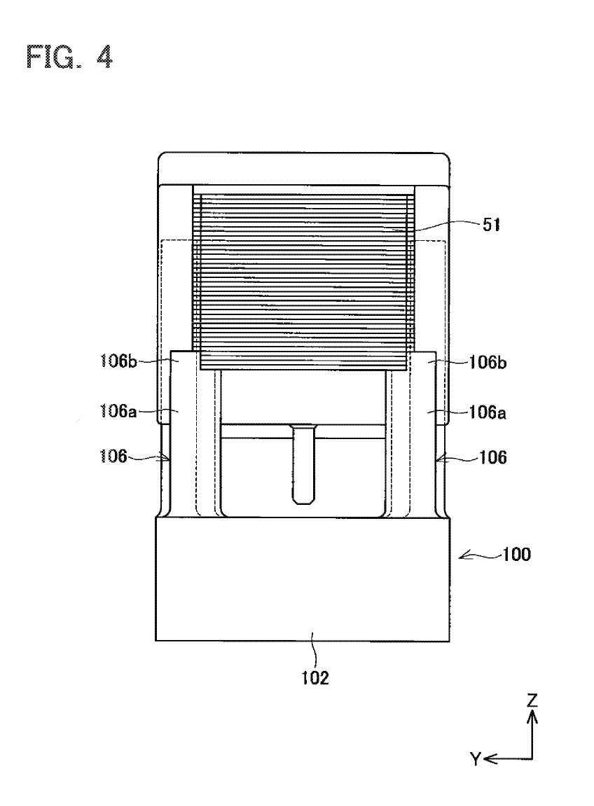

At each of two corners on a left end side of the base member 102, one end positioning member 106 is provided. As shown in FIG. 4, each of the end positioning members 106 comprises a lower supporting section 106a and a third positioning section 106b. The lower supporting section 106a has a rectangular parallelepiped shape and extends in the Z direction from the upper surface of the base member 102. An edge of the yoke 52 is placed on upper surfaces of two lower supporting sections 106a.

The third positioning section 106b is disposed on an upper surface of the lower supporting section 106a. In the state in which the first core 51 is set on the supporting device 100, the third positioning section 106b is in contact with an end face 52a of the yoke 52. The end face 52a is formed at a corner of the yoke 52 and inclines 45 degrees with respect to an X axis and a Y axis. The third positioning section 106b has a shape extending along the end face 52a. The third positioning section 106b prevents the first core 51 from deviating in a direction away from the second core 61 (i.e., the X direction) and the Y direction. As shown in FIG. 2, height (i.e., height from the upper surface of the lower supporting section 106a) of the third positioning section 106b is lower than the first and second positioning sections 104b and 104c. The lower supporting section 106a has same height as the lower supporting section 104a.

At each of two corners on a right end side of the upper surface of the base member 102, one end positioning member 107 is provided. The end positioning member 107 has a same shape as the end positioning member 106. Specifically, the end positioning member 107 includes a lower supporting section 107a and a third positioning section 107b. An edge of the yoke 62 is placed on upper surfaces of two lower supporting sections 107a. Like the third positioning section 106b, the third positioning section 107b is in contact with an end face 62a and prevents the second core 61 from deviating in a direction away from the first core 51 (i.e., the X direction) and the Y direction.

In the state in which the two cores 51 and 61 are placed on the supporting device 100, positions in the X direction of the two cores 51 and 61 are determined by the first positioning sections 104b and the third positioning sections 106b and 107b. Positions in the Y direction of the two cores 51 and 61 are determined by the second positioning sections 104c and the third positioning sections 106b and 107b. Positions in the Z direction of the two cores 51 and 61 are determined by the lower supporting sections 104a, 106a, and 107a.

After the two cores 51 and 61 are placed on the supporting device 100, the two cores 51 and 61 supported by the supporting device 100 are disposed in the molding die 200 (i.e., a state shown in FIG. 2). In this state, a clearance C1 between an outer circumferential surface of each of the cores 51 and 61 and the molding die 200 (i.e., between the yokes 52 and 62 and the molding die 200 opposed to the yokes 52 and 62 in the X direction) is larger than a clearance C2 between an inner circumference (i.e., a surface opposed to the rotor 44) of each of the cores 51 and 61 and the molding die 200. In this configuration, thickness T1 of the resin layer 14 that covers the outer circumference of each of the cores 51 and 61 is larger than thickness T2 of the resin layer 14 that covers the inner circumference of each of the cores 51 and 61.

Subsequently, molten metal of resin is injected into the molding die 200. When the resin solidifies, the resin layer 14 is formed. When the molten mental of the resin is injected into the molding die 200, the molten metal flows into a wider channel path first, i.e., the clearance C1 of the clearances C1 and C2. When the molten metal flows into the clearance C1, in each of the cores 51 and 61, non-opposing surfaces 55b and 65b are pressed against the first positioning section 104b by pressure of the molten metal. As a result, a positional relation between the first core 51 and the second core 61 is finally determined by the center positioning member 104.

With this configuration, it is possible to accurately determine a relative positional relation between the first core 51 and the second core 61 by increasing accuracy of a position and a dimension of the center positioning members 104. In other words, position and dimension accuracy of the end positioning members 106 and 107 does not have to be strictly adjusted. Further, it is unnecessary to set the end positioning members 106 and 107 as high as the center positioning members 104. Therefore, when the molten metal is injected into the molding die 200, it is possible to suppress the end positioning members 106 and 107 from preventing a smooth flow of the resin.

The molding die 200 includes a projecting section 202 for forming a space in which the rotor 44 is disposed, i.e., a motor chamber 46. A ridge section (not shown in the figure) extending in the Z direction is formed on an outer circumferential surface of the projecting section 202. The ridge section is disposed between the first teeth 54 and the second teeth 56 and between the first teeth 64 and the second teeth 66.

When the resin injected into the molding die 200 solidifies, the stator 50 including the resin layer 14 and the supporting device 100 are extracted from the molding die 200 and the supporting device 100 is removed. Consequently, the stator 50 in which the two cores 51 and 61 are covered with the resin layer 14 is formed.

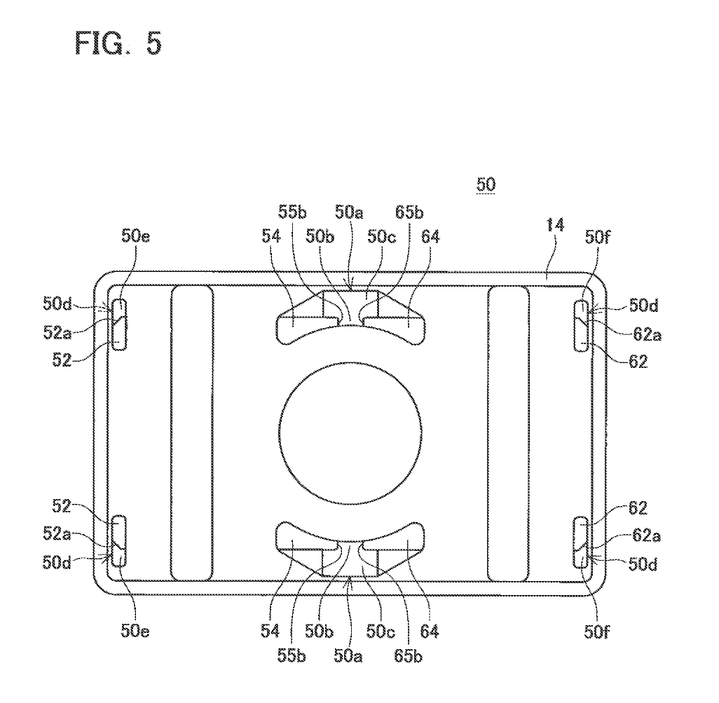

As shown in FIG. 5, in the stator 50, two center gaps 50a in which the center positioning members 104 have been inserted and four end gaps 50d in which the end positioning members 106 and 107 have been inserted are formed. Each of the gaps 50a and 50d is opened to a bottom surface side of the stator 50. Each of the center gaps 50a includes a first void 50b in which the first positioning member 104b has been inserted and a second void 50c in which the second positioning member 104 has been inserted.

Each of the first void 50b contacts the non-rotor side surfaces 55b and 65b. The first void 50b is located on the rotor 44 side of the second void 50c. The second void 50c contacts and communicates with the first void 50b on the rotor 44 side. The second void 50c contacts surfaces of front ends of the first teeth 54 and 64 on an opposite side of the rotor side surfaces 55a and 55b.

The end gap 50d formed on a left side includes a third void 50e in which the third positioning section 106b has been inserted. The end gap 50d formed on a right side includes a fourth void 50f in which the third positioning section 107b has been inserted. The third void 50e contacts the end face 52a. The fourth void 50f contacts the end face 62a. The first void 50b and the second void 50c are deeper than the third void 50e and the fourth void 50f. With this configuration, it is possible to set the first positioning section 104b and the second positioning section 104c higher than the third positioning sections 106b and 107b. It is possible to prevent each of the cores 51 and 61 from tilting with the pressure of the molten metal of the resin by setting the first positioning section 104b and the second positioning section 104c higher than the center of gravity of each of the cores 51 and 61.

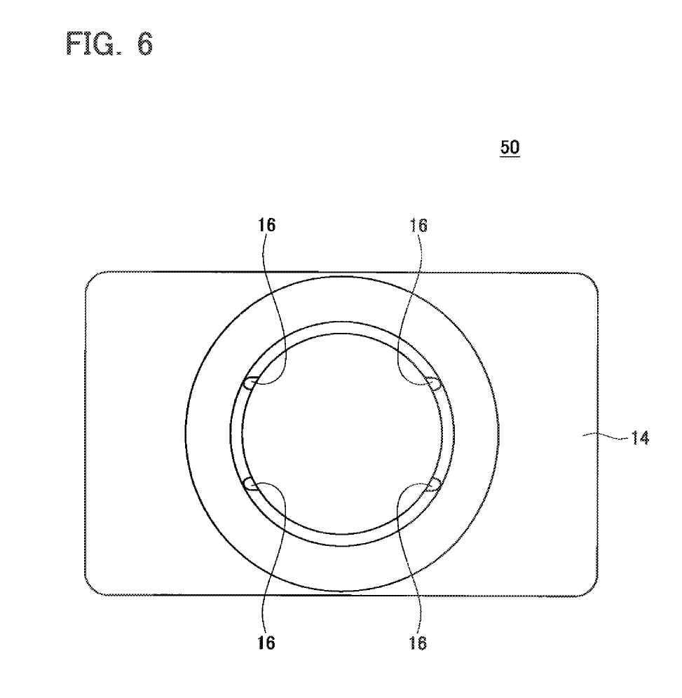

In a bottom view of the stator 50, portions of the two cores 51 and 61 in contact with the each center positioning member 104 of the first teeth 54 and 64 are exposed to the corresponding center gap 50a. Portions of the yokes 52 and 62 in contact with the end positioning members 106 and 107 are exposed to the corresponding end gap 50d. On the other hand, as shown in FIG. 6, in a plan view of the stator 50, the two cores 51 and 61 are not exposed.

In a position corresponding to the ridge section of the projecting section 202, four grooves 16 extending in an axis direction of the shaft 42, which is a rotation axis of the rotor 44, are formed. Specifically, two grooves 16 are formed between the teeth 54 and 56 and the other two grooves 16 are formed between the teeth 64 and 66.

(Operation of the Electric Pump 10)

An operation of the electric pump 10 is explained. When electric power is supplied from the control circuit 72 to the coil 68, the rotor 44 rotates about the fixed shaft 42. As a result, the impeller 30 rotates and the cooling water is sucked into the pump chamber 26 from the suction port 22. Pressure of the cooling water sucked into the pump chamber 26 is raised by rotation of the impeller 30. The cooling water is discharged to an outside of the casing 12 from the discharge port 24.

The pump chamber 26 communicates with the motor chamber 46 in which the rotor 44 is contained. Therefore, the cooling water flows into the motor chamber 46 as well. The motor chamber 46 is isolated from each of the cores 51 and 61 by the resin layer 14. Therefore, each of the cores 51 and 61 does not come into contact with the cooling water. In the motor chamber 46, the cooling water flows between the rotor 44 and the stator 50 and in the groove 16. Therefore, compared with a structure in which the groove 16 is not formed, it is possible to increase a channel area of the cooling water in the motor chamber 46. The cooling water can smoothly flow in the motor chamber 46 by passing through the groove 16. It is possible to accurately discharge air bubbles included in the cooling water in the motor chamber 46 to the pump chamber 26.

The pump chamber 26 and the circuit chamber 74 are isolated by the resin layer 14. Therefore, it is unnecessary to provide a partition wall for preventing the cooling water from intruding into the circuit chamber 74. Since the cooling water does not intrude into the circuit chamber 74, it is unnecessary to close an opening of each of the gaps 50a and 50d.

With the motor unit 40, when the resin layer 14 that connects the first core 51 and the second core 61 is molded by the insert molding, the first positioning section 104b is disposed in a position where the corresponding first void 500b is formed and the second positioning section 104c is disposed in a position where the corresponding second void 50c is formed. The first void 50b contacts the non-rotor side surface 55b of the first core 51 and the non-rotor side surface 65b of the second core 61. Therefore, the non-rotor side surfaces 55b and 65b are in contact with the first positioning section 104b disposed in the position where the corresponding first void 50b is formed. Therefore, first positioning of the first core 51 and the second core 61 can be performed by a part of the molding die 200 (i.e., a part of the supporting device 100) disposed in the position where the first void 50b is formed. Therefore, when the resin layer 14 is molded, it is possible to suppress the first core 51 and the second core 61 from positionally deviating in the direction along which the cores 51 and 61 approach (i.e., the X direction).

The second void 50c contacts a part (i.e., a surface extending in the X direction) of a surface of the first core 51 and a part (i.e., a surface extending in the X direction) of a surface of the second core 61. Therefore, the second positioning section 104c disposed in a position where the corresponding second void 50c is formed is also in contact with the part of the surface of the first core 51 and the part of the surface of the second core 61. Therefore, when the resin layer 14 is molded, second positioning of the first core 51 and the second core 61 can be performed by a part of the molding die 200 (i.e., a part of the supporting device 100) disposed in the position where the second void 50e is formed. Therefore, when the resin layer 14 is molded, it is possible to suppress the first core 51 and the second core 61 from positionally deviating in the Y direction. Therefore, since relative positions of the two cores 51 and 61 are determined by the resin layer 14 in a state in which the positional deviation is suppressed, it is possible to suppress relative positional deviation of the two cores 51 and 61.

In the embodiment explained above, each of the second void 50c is in contact with the corresponding first void 50b on the rotor 44 side. However, the second void 50c does not have to be in contact with the first void 50b. When the second void 50c is not in contact with the first void 50b, the first positioning member 104b and the second positioning member 104c do not have to be in contact with each other.

In the embodiment, each of the third voids 50e is in contact with the end face 52a. However, the third void 50e only has to be in contact with a part of a surface of the surface of the yoke 52 on an opposite side of the second core 61. For example, the third void 50e may be disposed in a vicinity of a center in the Y direction of the surface of the yoke 52 on the opposite side of the second core 61. Similarly, each of the fourth voids 50f only has to be in contact with a part of a surface of the surface of the yoke 62 on an opposite side of the first core 51. The number of each of third voids 50e and the number of fourth voids 50f may be one.

For example, the groove 16 does not have to extend in parallel to the axis direction of the shaft 42. For example, the groove 16 may incline in a rotating direction of the rotor 44.

1. A motor comprising:
a rotor; and
a stator configured to comprise a first core, a second core which opposes the first core, and a resin layer covering the first core and the second core so as to connect the first core and the second core,
wherein each of the first core and the second core comprises:
a yoke; and
three pieces of teeth configured to be disposed on the yoke, a rear end of each of the teeth being connected with the yoke, and a front end of each of the teeth opposing an outer circumference of the rotor with a clearance, and
the resin layer comprises:
a space configured to dispose the rotor;
a first void configured to: contact a first opposing surface of the first core, the first opposing surface opposing the second core; and contact a second opposing surface of the second core, the second opposing surface opposing the first core; and
a second void configured to: contact a first part of a surface of the first core, the first part extending parallel to a direction along which the first core opposes the second core; and contact a second part of a surface of the second core, the second part extending parallel to the direction along which the first core opposes the second core.

2. The motor as in claim 1, wherein
the resin layer further comprises:
a third void configured to contact a third part of the surface of the first core, the third part located on an opposite side from the second core; and
a fourth void configured to contact a fourth part of the surface of the second core, the fourth part located on an opposite side from the first core.

3. The motor as in claim 2, wherein
each of the first void, the second void, the third void and the fourth void opens at a lower end portion of the motor and extends from the lower end portion toward an upper end portion of the motor, and
the first void and the second void are deeper than the third void and the fourth void.

4. The motor as in claim 1, wherein
the three pieces of the teeth disposed on the same yoke comprise:
a pair of first teeth configured to connect to both edges of the yoke; and
a second tooth configured to connect to a center part of the yoke,
each of the pair of the first teeth of the first core opposes a corresponding one of the pair of the first teeth of the second core,
a front portion of each of the first teeth of the first core and the corresponding first teeth of the second core comprises an opposing area opposing the rotor and a non-opposing area not opposing the rotor,
for each of the pair of the first teeth of the first core, the first opposing surface is located in the non-opposing area of the first teeth, and
for each of the pair of the first teeth of the second core, the second opposing surface is located in the non-opposing area of the first teeth.

5. An electric pump comprising:
a motor as in claim 3;
an impeller configured to be activated by the motor;
a pump chamber configured to be disposed above the motor and contain the impeller rotatably;
a control circuit configured to control the motor; and
a control chamber configured to be disposed below the motor and contain the control circuit.

6. An electric pump comprising:
a motor as in claim 1;
an impeller configured to be activated by the motor; and
a pump chamber configured to contain the impeller rotatably.

7. The electric pump as in claim 6, wherein
the pump chamber is communicated with the space in which the rotor is disposed, and
a groove is disposed between two adjacent teeth on a surface of the resin layer opposing the rotor, and
the groove extends along a direction of a rotation axis of the rotor.
